(19) United States
(12) Patent Application Publication
(10) Pub. No.: US 2005/0111413 A1
(43) Pub. Date: May 26, 2005

(54) Wireless CDMA network having an efficient access channel and method of operation

(75) Inventors: Purva R. Rajkotia, Plano, TX (US); Chanakya Bandyopadhyay, Richardson, TX (US); Sanjay K. Kodali, Dallas, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/955,823

(22) Filed: Sep. 30, 2004

Related U.S. Application Data
(60) Provisional application No. 60/525,211, filed on Nov. 26, 2003.

(51) Int. Cl. H04B 7/216

(52) U.S. Cl. 370/335; 370/438; 370/441

(57) ABSTRACT

A base station and a mobile station for use in a CDMA2000-compatible wireless network that communicates mobile stations accessing the wireless network. The base station communicates with the mobile station in an access channel. The largest access channel message transmitted by the mobile station and received by the base station is comparable in size to an average access channel message transmitted by the mobile station and received by the base station. In particular, the Origination message and the Page Response message are comparable in size to the average access channel message.

### CROSS-REFERENCE TO RELATED APPLICATION AND CLAIM OF PRIORITY

The present invention is related to that disclosed in U.S. Provisional Patent Application Ser. No. 60/525,211, filed Nov. 26, 2003, entitled “Wireless CDA Network Having an Efficient Access Channel and Method of Operation”. U.S. Provisional Patent Application Ser. No. 60/525,211 is assigned to the assignee of the present application. The subject matter disclosed in U.S. Provisional Patent Application Ser. No. 60/525,211 is hereby incorporated by reference into the present disclosure as-if fully set forth herein. The present invention hereby claims priority under 35 U.S.C. §119(e) to U.S. Provisional Patent Application Ser. No. 60/525,211.

### TECHNICAL FIELD OF THE INVENTION

The present invention relates generally to wireless networks and, more specifically, to a CDMA wireless network that implements efficient access channel messages.

### BACKGROUND OF THE INVENTION

Businesses and consumers use a wide variety of fixed and mobile wireless terminals, including cell phones, pagers, Personal Communication Services (PCS) systems, and fixed wireless access devices (i.e., vending machine with cellular capability). To attract new customers and retain existing customers, wireless service providers continually try to improve the quality of wireless service. Typically, this means improving equipment in order to eliminate dropped calls and to increase bandwidth. However, to maintain profitability, wireless service providers must also support as many mobile stations (e.g., cell phones and other wireless devices) as possible on each base station of a wireless network. Often these two efforts conflict with each other, since increasing the number of mobile stations often decreases service quality by increasing the number of dropped calls.

The quality of service provided by a code-division multiple access (CDMA) wireless network may be affected by the size of access channel messages transmitted by the mobile stations. In conventional CDMA networks (e.g., IS-2000 networks), the base station transmits an Access Parameters message containing a maximum capsule size (MAX_CAP_SZ) parameter to a mobile station. The mobile station then sets the size of the access channel message capsule according to the value of the MAX_CAP_SZ parameter. The MAX_CAP_SZ parameter has a value from 0 to 7 (000 to 111 in binary). The MAX_CAP_SZ parameter determines the number of frames sent in an access channel message. These values from 0 to 7 correspond to 3 frames to 10 frames, respectively. In other words, the minimum number of frames is 3 (MAX_CAP_SZ=000) and the maximum number of frames is 10 (MAX_CAP_SZ=111).

The base station normally selects the size of the MAX_CAP_SZ parameter according to the size of the largest access channel message the mobile station is expected to transmit. The problem with this approach is that the mobile station uses the same MAX_CAP_SZ parameter to set the number of frames in all access channel messages, even small-sized access channel messages.

FIG. 3 illustrates an access channel message capsule according to an exemplary embodiment of the prior art. For example, if the MAX_CAP_SZ parameter is 4 (or 100), then there are seven (7) frames (labeled F1 through F7) in each access channel message capsule. If the average access channel message is only four frames long (F1-F4), then the other three frames (F5-F7) are null (or wasted) frames.

By way of example, in CDMA2000 networks, the Origination message (ORM) and the Page Response message (PRM) are much larger than any other access channel message and are much larger than the average access channel message. Thus, setting the MAX_CAP_SZ parameter to accommodate the ORM and the PRM means that all of the remaining access channel messages are transmitted with wasted frames. This is a wasteful and inefficient method of operating the access channel.

Therefore, there is a need in the art for an improved wireless network that implements an efficient access channel messaging scheme.

### SUMMARY OF THE INVENTION

The present invention increases the efficiency of the access channel by reducing the size of the largest access channel messages. This is done without impacting the call set-up procedure. In particular, the present invention makes the size of the largest access channel messages (e.g., Origination message, page Response message) closer to the size of the average access channel messages in a conventional CDMA network. Since the largest access channel message is now close to the size of the average access channel message, there are very few, if any, wasted frames in each access channel message capsule.

To address the above-discussed deficiencies of the prior art, it is a primary object of the present invention to provide a base station for use in a CDMA2000-compatible wireless network capable of communicating with a plurality of mobile stations accessing the wireless network. According to an advantageous embodiment of the present invention, the base station is capable of communicating with the mobile stations in an access channel, wherein a largest access channel message received by the base station is comparable in size to an average access channel message received by the base station.

It is another primary object of the present invention to provide a mobile station for use in a CDMA2000-compatible wireless network. According to an advantageous embodiment of the present invention, the mobile station is capable of accessing the wireless network and communicating with the wireless network in an access channel, wherein a largest access channel message transmitted by the mobile station is comparable in size to an average access channel message transmitted by the mobile station.

According to one embodiment of the present invention, an Origination message transmitted by the mobile station and received by the base station is comparable in size to an average access channel message associated with a conventional CDMA2000 network.

According to another embodiment of the present invention, a Page Response message transmitted by the mobile station and received by the base station is comparable in size to an average access channel message associated with a conventional CDMA2000 network.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that uses efficient access channel messages according to the principles of the present invention;

FIGS. 2A-2D illustrates an exemplary origination message for use in the exemplary wireless network in FIG. 1 according to one embodiment of the present invention;

FIG. 3 illustrates an access channel message capsule according to an exemplary embodiment of the prior art;

FIG. 4 illustrates an access channel message capsule according to an exemplary embodiment of the present invention; and

FIG. 5 illustrates the exemplary origination message in FIG. 2 with the unnecessary fields removed.

### DETAILED DESCRIPTION OF THE INVENTION

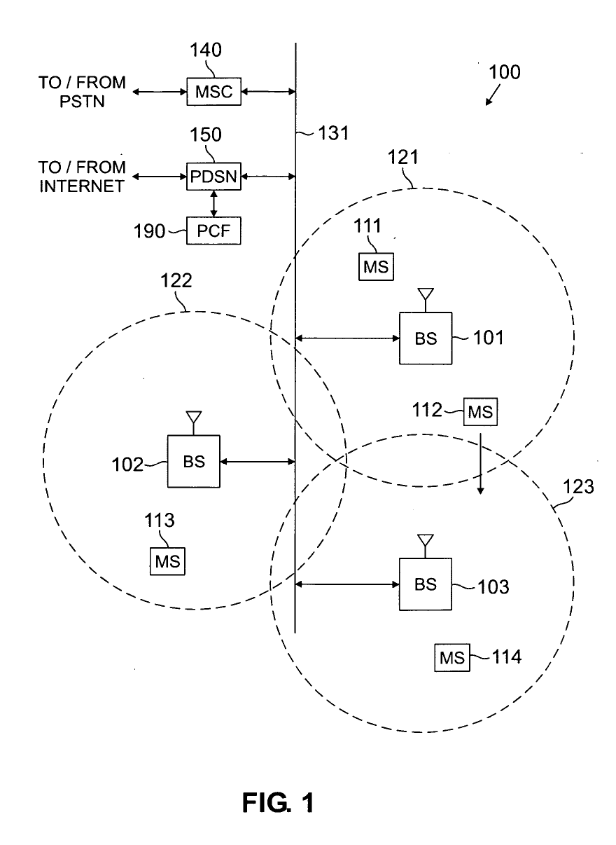

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, which uses efficient access channel messages according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to the IS-2000C standard (i.e., Release C of cdma2000). In an advantageous embodiment of the present invention, MS 111-114 are capable of receiving data traffic and/or voice traffic on two or more CDMA channels simultaneously. Mobile stations 111-114 may be any suitable wireless devices, including conventional cellular radiotelephones, PCS handset devices, personal digital assistants, portable computers, telemetry devices, and the like, which are capable of communicating with base stations 101-103 via wireless links.

The present invention is not limited to mobile devices. Other types of wireless access terminals, including fixed wireless terminals, may be used. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., monitoring devices with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

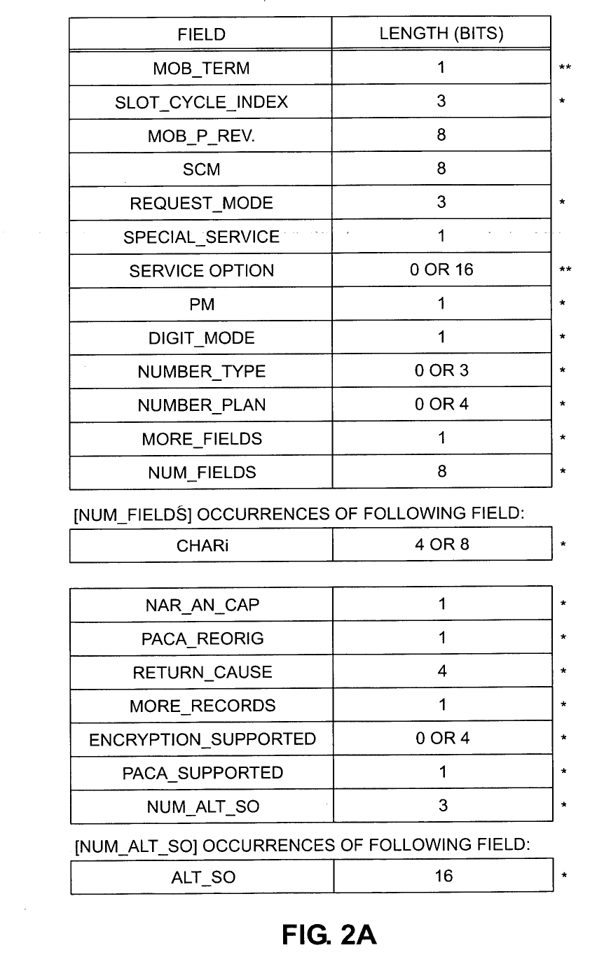

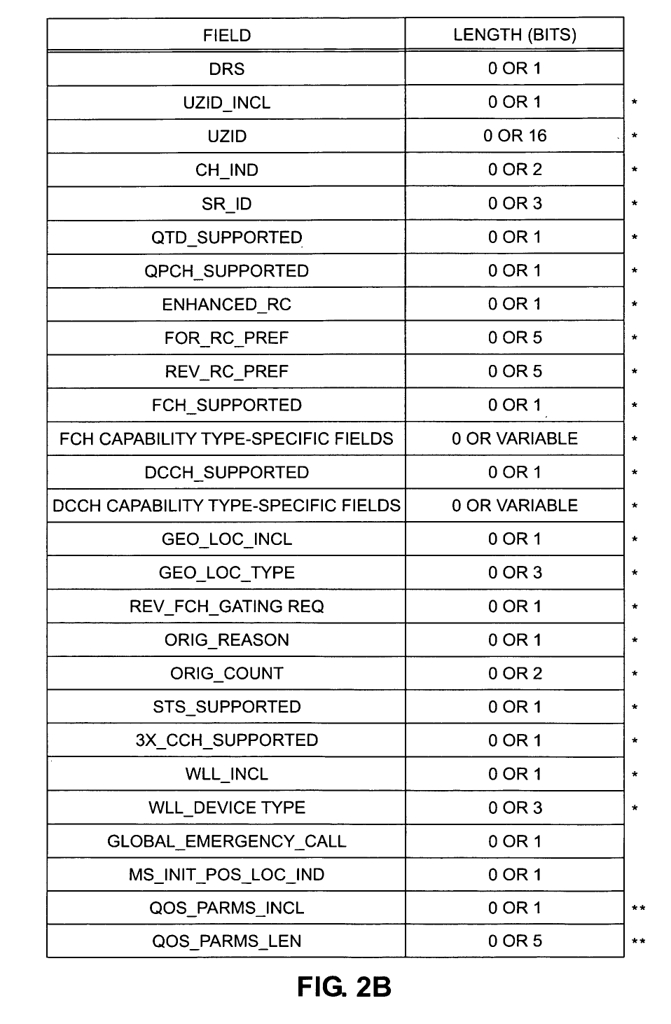

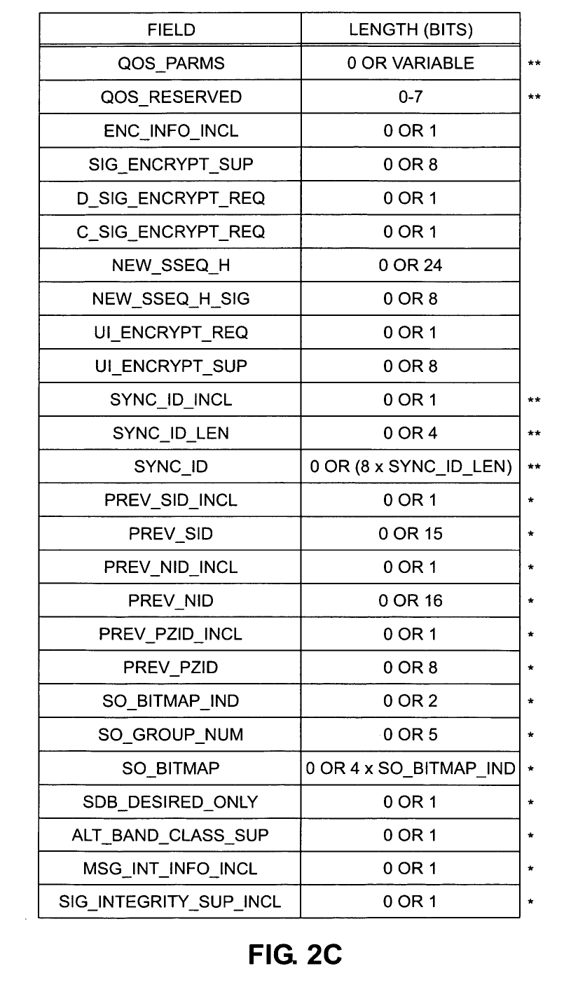

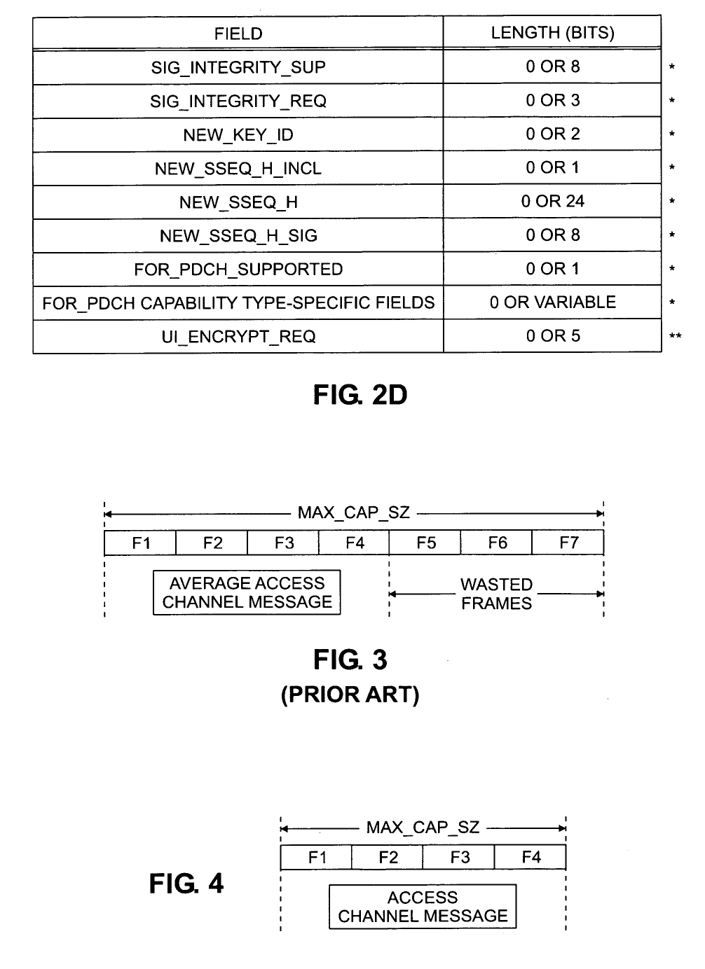

As is well known in the art, each of cell sites 121-123 is comprised of a plurality of sectors (shown in FIG. 2), where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, BS 101, BS 102, and BS 103 comprise a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystem in each of cells 121, 122, and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

FIGS. 2A-2D illustrate an exemplary Origination message (OEM) transmitted by mobile stations 111-114 in exemplary wireless network 100 according to one embodiment of the present invention. The new Origination message is illustrated by listing the fields of a conventional CDMA2000 Origination message and marking deleted fields with a single asterisk and optional fields with two asterisks. The present invention proposes that the sizes of the larger access channel messages (e.g., Origination message, Page Response message) be reduced to the size of most of the other access channel messages.

This limits the variance in the size of the access channel messages, so that the maximum capsule size (MAX_CAP_SZ) parameter will be closer to the size of the average access channel message. Thus, the MAX_CAP_SZ parameter is reduced and there is much less inefficiency when smaller access channel messages are transmitted by a mobile station in the reverse channel.

A smaller MAX_CAP_SZ parameter value also reduces collision probabilities in the access channel, which results in an increase in access channel bandwidth usage and reduction in access channel probes. A reduction in access channel probes further helps in fast call setup. Since the average number of mobile stations hashing to the same slot is reduced, there is an increase in efficiency.

In a conventional CDMA2000 network, the largest access channel messages are the Origination message (ORM) and the Page Response message (PRM). According to the principles of the present invention, the new Origination message and the new Page Response message are modified (reduced in size) by removing certain data fields without impacting call setup procedures. The removed data fields are subsequently transmitted in the access channel or in a traffic channel after the new, modified Origination message has set up the traffic channel.

As noted above, an exemplary modified Origination message is shown in FIG. 2. The modified Origination message in FIG. 2 comprises a conventional Origination field in which the removed data fields are marked with asterisks. The fields marked by a single asterisk are not transmitted in the new modified Origination message. The fields marked by two asterisks are optional fields that may be included in the new modified Origination message. In the case of a Page Response message, a modified Page Response message is constructed in a manner similar to the modified Origination message, since many of the fields in a Page Response message are the same as in an Origination message.

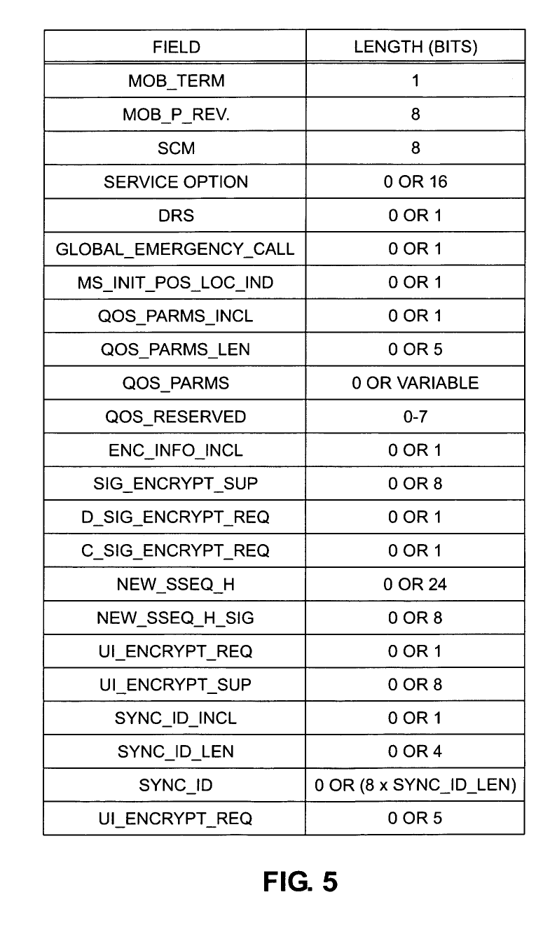

FIG. 5 illustrates the exemplary new Origination message of FIG. 2 with the unnecessary fields removed. As FIG. 5 illustrates, the exemplary new Origination message is much smaller than a conventional CDMA2000 Origination message. The data fields removed from the conventional Origination message may be sent in separate messages in the access channel or in the traffic channel because these parameters are not critical for call setup. These data fields are generally related to: i) alternate service options; ii) encryption parameters; iii) QoS parameters; and iv) mobile capability information.

It should be noted, however, that the exact choices of deleted fields and retained fields depicted in FIGS. 2 and 4 are by way of example only. The illustrative embodiment should not be construed to limit the scope of the present invention. In alternate embodiments, a different set of data field may be delete from or retained in the exemplary Origination message. In any event, the present invention may be readily implemented in conventional CDMA2000 mobile stations and conventional CDMA2000 base stations by modifying the access channel message control software to implement the new, shorter Origination messages, Page Response messages, and the like.

As mentioned above, the MAX_CAP_SZ parameter in prior art wireless networks is determined by the largest possible message to be sent on the Access Channel. When the mobile station transmits smaller messages, the access channel still uses the MAX_CAP_SZ number of frames reserved for that message. Since a smaller access channel message does not need that many frames, the extra frames are wasted. This is very inefficient way of transmitting information on the access channel.

FIG. 4 illustrates an access channel message capsule transmitted by mobile stations 111-114 according to an exemplary embodiment of the present invention. As FIG. 4 illustrates, the access channel message capsule comprises four frames (F1 through F4). The average access channel message is of a comparable size. Since the present invention reduces the size of the largest access channel message to approximately the size of the majority of access channel messages, the inefficiency in the use of the access channel is reduced. The base station still specifies the MAX_CAP_SZ parameter for the size of the largest access channel message, but the largest access channel message will not be very different in size than the average access channel message.

As a general rule, the MAX_CAP_SZ parameter should be the same order of magnitude as the size of the majority of access channel messages. Preferably, the MAX_CAP_SZ parameter is no more than twice the size of the average access channel message. For example, in one embodiment of the present invention, BS 101 may transmit a MAX_CAP_SZ parameter that is no more than 125% of the average access channel message. Thus, if the average access channel message is no more than four frames in size, the MAX_CAP_SZ parameter is set to five frames. In another embodiment of the present invention, BS 101 may transmit a MAX_CAP_SZ parameter that is no more that 150% of the average access channel message. Thus, if the average access channel message is no more than four frames in size, the MAX_CAP_SZ parameter is set to six frames.

Although the present invention has been described with an exemplary embodiment, various changes and modifications may be suggested to one skilled in the art. It is intended that the present invention encompass such changes and modifications as fall within the scope of the appended claims.

1. For use in a CDMA2000-compatible wireless network capable of communicating with a plurality of mobile stations accessing said wireless network, a base station capable of communicating with said mobile stations in an access channel, wherein a largest access channel message received by said base station is comparable in size to an average access channel message received by said base station.

2. The base station as set forth in claim 1, wherein said largest access channel message is of the same order of magnitude in size as said average access channel message.

3. The base station as set forth in claim 1, wherein said largest access channel message is no more than twice the size of said average access channel message.

4. The base station as set forth in claim 1, wherein said largest access channel message is no more than 150% of the size of said average access channel message.

5. The base station as set forth in claim 1, wherein said largest access channel message is no more than 125% of the size of said average access channel message.

6. The base station as set forth in claim 1, wherein an Origination message received by said base station is comparable in size to an average access channel message associated with a conventional CDMA2000 network.

7. The base station as set forth in claim 1, wherein a Page Response message received by said base station is comparable in size to an average access channel message associated with a conventional CDMA2000 network.

8. A wireless network comprising a plurality of base station capable of communicating with a plurality of mobile stations according to the CDMA2000 standard, wherein each of said base station is capable of communicating with said mobile stations in an access channel, wherein a largest access channel message received by said each base station is comparable in size to an average access channel message received by said each base station.

9. The wireless network as set forth in claim 8, wherein said largest access channel message is of the same order of magnitude in size as said average access channel message.

10. The wireless network as set forth in claim 8, wherein said largest access channel message is no more than twice the size of said average access channel message.

11. The wireless network as set forth in claim 8, wherein said largest access channel message is no more than 150% of the size of said average access channel message.

12. The wireless network as set forth in claim 8, wherein said largest access channel message is no more than 125% of the size of said average access channel message.

13. The wireless network as set forth in claim 8, wherein an Origination message received by said each base station is comparable in size to an average access channel message associated with a conventional CDMA2000 network.

14. The wireless network as set forth in claim 8, wherein a Page Response message received by said each base station is comparable in size to an average access channel message associated with a conventional CDMA2000 network.

15. For use in a CDMA2000-compatible wireless network, a mobile station capable of accessing said wireless network and communicating with said wireless network in an access channel, wherein a largest access channel message transmitted by said mobile station is comparable in size to an average access channel message transmitted by said mobile station.

16. The mobile station as set forth in claim 15, wherein said largest access channel message is of the same order of magnitude in size as said average access channel message.

17. The mobile station as set forth in claim 15, wherein said largest access channel message is no more than twice the size of said average access channel message.

18. The mobile station as set forth in claim 15, wherein said largest access channel message is no more than 150% of the size of said average access channel message.

19. The mobile station as set forth in claim 15, wherein said largest access channel message is no more than 125% of the size of said average access channel message.

20. The mobile station as set forth in claim 15, wherein an Origination message transmitted by said mobile station is comparable in size to an average access channel message associated with a conventional CDMA2000 network.

21. The mobile station as set forth in claim 15, wherein a Page Response message transmitted by said mobile station is comparable in size to an average access channel message associated with a conventional CDMA2000 network.
